(19) United States
(12) Patent Application Publication
(10) Pub. No.: US 2003/0186689 A1
(43) Pub. Date: Oct. 2, 2003

(54) System and method for IOTA software download notification for wireless communication devices

(75) Inventors: Sudhindra P. Herle, Plano, TX (US); Bryan J. Moles, Dallas, TX (US)

Correspondence Address: Docket Clerk, P.O. Drawer 800889, Dallas, TX, 75380, US

(73) Assignee: SAMSUNG ELECTRONICS CO., LTD, Suwon-city (KR)

(21) Appl. No.: 10/425,910

(22) Filed: Apr. 29, 2003

Related U.S. Application Data
(63) Continuation-in-part of application No. 10/017,050, filed on Dec. 13, 2001.
(60) Provisional application No. 60/310,511, filed on Aug. 6, 2001.

(51) Int. Cl. H04M 3/00

(52) U.S. Cl. 455/418; 455/422.1; 455/425

(57) ABSTRACT

A wireless communication device capable of being upgraded from a software upgrade server via a wireless communication network. The wireless communication device comprises: 1) a memory capable of storing a user profile, wherein the user profile is suitable for managing an un-attended software download; and 2) a message processor associated with the memory capable of communicating with the software upgrade server via the wireless communication network, wherein the message processor receives at least a first un-attended notification message from the software upgrade server identifying a new software update to be applied to the wireless communication device.

### CROSS-REFREENCE TO RELATED APPLICATION

This application is a continuation-in-part (CIP) of U.S. patent application Ser. No. 10/017,050, filed Dec. 13, 2001, entitled “IOTA SOFTWARE DOWNLOAD VIA AUXILIARY DEVICE”, which claims the benefit of U.S. Provisional Application Serial No. 60/310,511 filed Aug. 6, 2001. The disclosure of related patent application Ser. No. 10/017,050 is hereby incorporated by reference into the present disclosure as if fully set forth herein.

### TECHNICAL FIELD OF THE INVENTION

The present invention is directed, in general, to Internet over-the-air software downloads to wireless communication devices and, more specifically, to wireless software download notification for wireless communication devices capable of accessing the Internet.

### BACKGROUND OF THE INVENTION

As wireless communication devices such as mobile telephones and personal digital assistants (PDAs) become increasingly prevalent, the need for software downloads to such devices (e.g., to upgrade operating system software, update applications, or add after-market functionality) will also increase. Wireless communication devices capable of accessing the Internet (sometimes referred to as Internet over-the-air or “IOTA”) are particularly likely to require such software downloads. Wireless software downloads would be preferable in such cases to avoid the necessity of providing a separate Internet connection mechanism simply for software downloads.

Wireless performance of software downloads to wireless Internet-access devices is currently the subject of considerable effort, but standardization of such wireless downloads is challenging due to the wide disparity in technology employed by wireless devices. Wireless software downloads may be achieved by a variety of means including file transfer protocol (FTP), trivial file transfer protocol (TFTP), and the like. However, all of these methods require running the entire network protocol stack—including the radio frequency (RF), call processing, and transmission control protocol/Internet protocol (TCP/IP) layers—on the wireless communication device in order to download new software.

Currently, a user of a wireless communication device is required to poll a predefined website designated by the operator or manufacture to find out if any new software updates are available. However, this presents a problem with regard to the certainty that the user is aware of all software updates in a timely manner and that all users have applied critical software updates.

There is, therefore, a need in the art for providing a system and method for Internet over-the-air software download notification. In particular, there is a need for automatic notification of wireless communication devices capable of wireless connection to the Internet.

### SUMMARY OF THE INVENTION

It is an object of the present invention to overcome the above-discussed deficiencies of the prior art, and more specifically, it is a primary object of the present invention to provide a system and method for Internet over-the-air software download notification for wireless communication devices.

It is another object of the present invention to provide a wireless communication device capable of being upgraded from a software upgrade server via a wireless communication network. According to an advantageous embodiment of the present invention, the wireless communication device comprises: 1) a memory capable of storing a user profile, wherein the user profile is suitable for managing an un-attended software download; and 2) a message processor associated with the memory capable of communicating with the software upgrade server via the wireless communication network, wherein the message processor receives at least a first un-attended notification message from the software upgrade server identifying a new software update to be applied to the wireless communication device.

It is still another object of the present invention to provide a communication system capable of upgrading a wireless communication device from a software upgrade server via a wireless communication network. According to an advantageous embodiment of the present invention, the communication system comprises a wireless communication device capable of being upgraded from a software upgrade server via a wireless communication network comprising: 1) a memory capable of storing a user profile, wherein the user profile is suitable for managing an un-attended software download; and 2) a message processor associated with the memory capable of communicating with the software upgrade server via the wireless communication network, wherein the message processor receives at least a first un-attended notification message from the software upgrade server identifying a new software update to be applied to the wireless communication device.

These and other advantages and features of the present invention will become readily apparent to those skilled in the art upon examination of the subsequent detailed description and accompanying drawings. Accordingly, additional advantages and features of the present invention and the scope thereof are pointed out with particularity in the claims and form a part hereof.

### BRIEF DESCRIPTION OF THE DRAWINGS

A more complete understanding of the present invention, its preferred embodiments, further objects, and advantages thereof, will become more apparent by reference to the following detailed description taken in conjunction with the accompanying drawings, wherein like reference numbers indicate like elements, and in which:

FIG. 1 illustrates selected portions of an exemplary communication system according to one embodiment of the present invention; and

FIG. 2 illustrates a high-level flow diagram of a process for Internet over-the-air software download notification for a wireless communication device, according to one embodiment of the present invention.

### DETAILED DESCRIPTION OF THE INVENTION

Reference will now be made to the following detailed description of the exemplary embodiments of the present invention. Those skilled in the art will recognize that the present invention provides many inventive concepts and novel features that are merely illustrative and are not to be construed as restrictive. Accordingly, the specific embodiments discussed herein are given by way of example and should not be construed to limit the scope of the present invention.

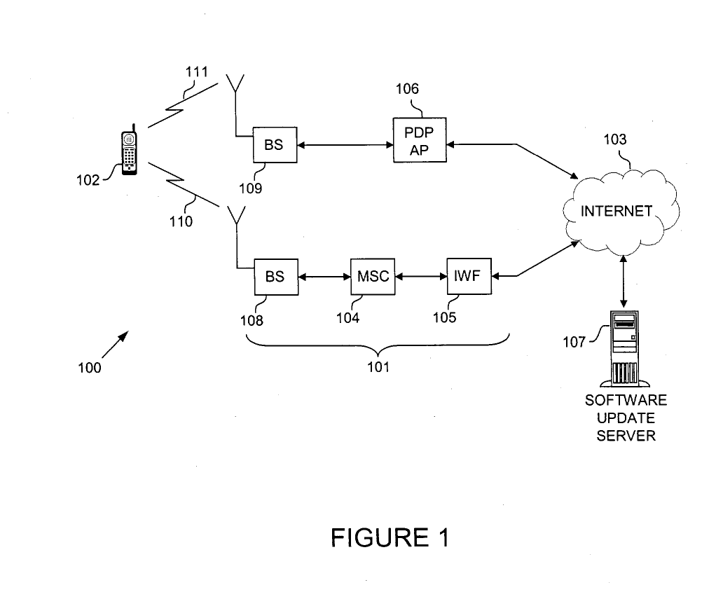

FIG. 1 illustrates selected portions of an exemplary communication system 100 according to one embodiment of the present invention. Communication system 100 comprises a wireless communication network 101 coupling a wireless communication device 102 to Internet 103 and software update server 107. Wireless communication network 101 also comprises mobile switching center (MSC) 104, inter-working function (IWF) 105, packet data protocol (PDP) access point (AP) 106, and base stations (BS) 108 and 109.

Radio frequency (RF) communication links 110 and 111 provide the operable connection between base stations (BS) 108 and 109 and wireless communication device 102. Wireless communication device 102 may be any wireless communication device, including, but not limited to, conventional cellular telephones, paging devices, personal digital assistant devices, text-message transmission devices, portable computers, or the like.

Wireless connectivity between the wireless communication device 102 and the Internet 103 is provided by wireless communication network 101 through, for example, a mobile switching center (MSC) 104 and inter-working function (IWF) 105, or through a packet data protocol (PDP) access point (AP) 106 for a general packet radio service (GPRS) gateway GPRS support node (GGSN).

Those skilled in the art will recognize that the complete structure and operation of a wireless communication network and other components within communication system 100 are not depicted or described. The present invention may be employed in conjunction with known wireless communication networks and other components, and only so much of those components as is unique to the present invention or necessary for an understanding of the present invention are depicted and described.

In order to receive wireless software download notifications, wireless communication device 102 employs the wireless connection to Internet 103 provided by wireless communication network 101 to access software update server 107. Software update server 107 contains software to be downloaded to and installed within wireless communication device 102 for either replacing or augmenting existing software.

According to the principles of the present invention, wireless communication device 102 comprises a memory (not shown), message processor (not shown) and custom software to manage the entire procedure for the un-attended reception, software download, and installation of software described below. The message processor further allows, for example, software registration, security and encryption keys associated with wireless communication device 102 to be employed in downloading the software without transfer of such keys to any intermediate devices.

According to an advantageous embodiment of the present invention, the wireless software download notification is initiated when new software becomes available. In such an embodiment, software update server 107 sends out a special-purpose broadcast notification message via wireless communication network 101 to all wireless communication devices to which the software update applies. The special-purpose, specially-formatted broadcast message may be delivered to wireless communication device 102 using a variety of means, including short message service (SMS), multimedia messaging (MMS), email, special data burst messages, broadcast information on shared channels, or the like. In this advantageous embodiment, the specially formatted broadcast message contains at least one record, furthermore, each record may comprise a file name, file size, checksum, flag indicating if this is a mandatory software module, recommended download server (for geographical load balancing), or the like.

Accordingly, wireless communication device 102 receives the un-attended specially formulated broadcast message and the message processor checks the user-preferences stored in memory for the appropriate downloading profile. Depending on the content of the message, and the available battery life, wireless communication device 102 may begin downloading the software-update asynchronously. Alternatively, the user-preferences may require a user consultation prior to the downloading or loading of the software. Therefore, wireless communication device 102 may process the specially formatted message and prompt the user via the MMI for processing instructions.

Once the software is downloaded in its entirety, the message processor determines the appropriate time for wireless communication device 102 to enter a program mode. During the program mode, the wireless communication device 102 no longer communicates with wireless network 101 (i.e., wireless communication device 102 goes “off the air”). Wireless communication device 102 proceeds to program the buffered software update, installing the downloaded software for either replacing or augmenting the existing software. Once the programming and installation is complete, if needed, wireless communication device 102 restarts or “reboots” in order to effectively utilize the newly loaded software.

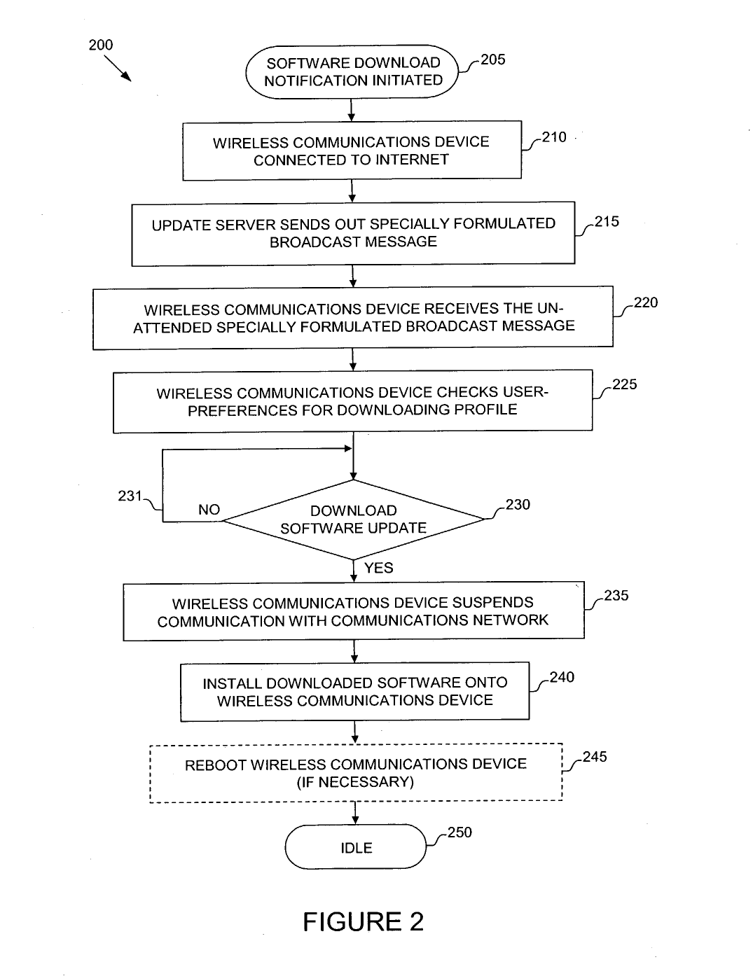

FIG. 2 illustrates a high-level flow diagram of a process for Internet over-the-air software download notification for a wireless communication device, according to one embodiment of the present invention. The process 200 begins with a wireless software download to a wireless communication device capable of Internet access (process step 205). In order to receive wireless software download notifications, wireless communication device 102 connects to Internet 103 provided by wireless communication network 101 to access software update server 107 (process step 210).

When new software becomes available, software update server 107 sends out a specially formatted, specific-purpose broadcast message to all wireless communication devices to which the software update applies, via wireless communication network 101 (process step 215). Wireless communication device 102 receives the un-attended specially formatted broadcast message from software update server 107 (process step 220). The message processor of wireless communication device 102 checks the user-preferences for the appropriate downloading profile (process step 225).

Depending on the content of the message and the available battery life, wireless communication device 102 may begin downloading the software-update or may initiate a consultation with the user prior to the downloading or loading of the software. Thereinafter, the software update from software update server 107 is downloaded to wireless communication device 102, via wireless communication network 101 (process step 230). Alternatively, wireless communication device 102 enters into a delay loop (process step 231) wherein the downloading of the software-update is not initiated until such time as indicated by the downloading profile.

Thereafter, wireless communication device 102 enters a program mode, in which the wireless communication device 102 no longer communicates with wireless network 101 (process step 235). Wireless communication device 102 proceeds to program the buffered software update, installing the downloaded software for either replacing or augmenting of existing software (process step 240). If necessary, once the programming and installation is complete, wireless communication device 102 restarts or “reboots” in order to effectively utilize the newly loaded software (process step 245).

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. For use in a communication system, a wireless communication device capable of being upgraded from a software upgrade server via a wireless communication network, said wireless communication device comprising:
a memory capable of storing a user profile, wherein said user profile is suitable for managing an un-attended software download; and
a message processor associated with said memory capable of communicating with said software upgrade server via said wireless communication network, wherein said message processor receives at least a first un-attended notification message from said software upgrade server identifying a new software update to be applied to said wireless communication device.

2. The wireless communication device according to claim 1, wherein the wireless communication device is a cellular telephone.

3. The wireless communication device according to claim 1, wherein said message processor reads a user preference from said user profile in response to said un-attended notification message received from said software upgrade server.

4. The wireless communication device according to claim 3, wherein said first un-attended notification message is delivered to said wireless communication device via a short message service from said software update server.

5. The wireless communication device according to claim 3, wherein said wireless communication device enters a program mode and installs said new software update.

6. The wireless communication device according to claim 5, wherein said new software update, replaces existing software on said wireless communication device.

7. The wireless communication device according to claim 5, wherein said new software update, augments existing software on said wireless communication devices.

8. A communication system, comprising:
a wireless communication device capable of being upgraded from a software upgrade server via a wireless communication network;
a memory capable of storing a user profile, wherein said user profile is suitable for managing an un-attended software download; and
a message processor associated with said memory capable of communicating with said software upgrade server via said wireless communication network, wherein said message processor receives at least a first un-attended notification message from said software upgrade server identifying a new software update to be applied to said wireless communication device.

9. The communication system according to claim 8, wherein the wireless communication device is a cellular telephone.

10. The communication system according to claim 8, wherein said message processor reads a user preference from said user profile in response to said un-attended notification message received from said software upgrade server.

11. The communication system according to claim 10, wherein said first un-attended notification message is delivered to said wireless communication device via a short message service from said software update server.

12. The communication system according to claim 10, wherein said wireless communication device enters a program mode and installs said new software update.

13. The communication system according to claim 12, wherein said new software update, replaces existing software on said wireless communication device.

14. The communication system according to claim 12, wherein said new software update, augments existing software on said wireless communication devices.

15. For use in a communication system, a method of performing wireless software download notifications to a wireless communication device capable of Internet access comprising the steps of:
storing a user profile within a memory of the wireless communication device;
receiving from a software update server at least a first un-attended notification message through a message processor;
identifying a new software update to be applied to the wireless communication device; and
downloading the new software update to the wireless communication device.

16. The method according to claim 15, wherein the wireless communication device is a cellular telephone.

17. The method according to claim 15, wherein the message processor reads a user preference from the user profile in response to the un-attended notification message received from the software upgrade server.

18. The method according to claim 17, wherein the step of receiving from a software update server at least a first un-attended notification message by a message processor further comprises:
delivering the first un-attended notification message to the wireless communication device via a short message service from the software update server.

19. The method according to claim 17, wherein the step of downloading the new software update to the wireless communication device further comprises:
replacing existing software on the wireless communication device.

20. The method according to claim 17, wherein the step of downloading the new software update to the wireless communication device further comprises:
augmenting existing software on the wireless communication device.
